(19) United States
(12) Patent Application Publication
(10) Pub. No.: US 2005/0108930 A1
(43) Pub. Date: May 26, 2005

(54) Processed biosolids for mulch seeding operations

(76) Inventors: Dwight D. Bowman, Ithaca, NY (US); David L. Jenkins, Canberra (AU)

Correspondence Address: BROWN & MICHAELS, PC;400 M & T BANK BUILDING, 118 NORTH TIOGA ST, ITHACA, NY, 14850, US

(21) Appl. No.: 10/936,266

(22) Filed: Sep. 8, 2004

Related U.S. Application Data
(60) Provisional application No. 60/501,300, filed on Sep. 9, 2003.

(51) Int. Cl. C09K 17/52

(52) U.S. Cl. 47/9

(57) ABSTRACT

A process for treatment of organic wastes from municipal wastewater to produce a product for spreading seed in an organic matrix includes the steps of providing organic waste including biosolids and their contained cellulose from municipal wastewater, rendering the organic waste free of foreign objects, rendering the organic waste pathogen free, and sterile relative to plant seeds, by milling in a batch or semi-batch format using a rotor-stator mixer or mill, and mixing the milled organic waste with waste paper products and/or pelletizing the mixture to form a horticultural mulch, to which seed can be added. The pH optionally is adjusted, and additional materials that aid in seed germination or plant growth optionally are mixed into the treated product. The final product is a high quality, beneficial re-use organic soil amendment that provides an enriched seed starter system for lawns or other commercial turf-grass operations.

### REFERENCE TO RELATED APPLICATIONS

This application claims an invention which was disclosed in Provisional Application No. 60/501,300, filed Sep. 9, 2003, entitled “PROCESSED BIOSOLIDS FOR MULCH SEEDING OPERATIONS”. The benefit under 35 USC § 119 (e) of the U.S. provisional application is hereby claimed, and the complete disclosure of the aforementioned application is hereby incorporated herein by reference in its entirety.

### BACKGROUND OF THE INVENTION

1. Field of the Invention

The present invention pertains to the field of horticultural mulches. More particularly, the invention pertains to compositions and methods for using municipal sewage sludge or biosolids for the production of mulch for providing ground cover when seeding.

2. Description of Related Art

More than $2 billion is spent annually treating and managing approximately 5.3 million dry metric tons of biosolids from publicly owned wastewater treatment plants in the United States (WEF/U.S. EPA Biosolids Fact Sheet Project, Biosolids: A Short Explanation and Discussion, 2000). Land application of biosolids, often to food crops, has gained popularity and widespread approval from the scientific and environmental communities and has increased over the years. National biosolids generation rates are estimated to reach 47 dry pounds per American yearly. In 1972, 20 percent of all U.S. biosolids were land applied, while 40 percent went to landfills. In 1989, about 33 percent of total biosolids were land applied, while 34 percent went to landfills. By 1995, 36 percent of all yearly biosolids were land applied, while 38 percent went to landfills. The remainder of the material was incinerated or surface disposed. Disposing of biosolids by shipment to landfills is considered a beneficial use only when such disposal includes methane gas recovery for fuel. Methane operations are relatively rare, however, which establishes land application for soil conditioning and fertilizer as the primary beneficial use of biosolids.

According to the WEF/U.S. EPA Biosolids Fact Sheet, biosolids can provide essential plant nutrients, water and organic matter, which can improve the physical condition of soil and render it a more favorable environment to manage nutrients and water. Biosolids contain all the elements essential for the growth of higher plants. Because nitrogen and phosphorus are the most abundant major plant nutrients in biosolids, the material's agricultural use is almost exclusively as a supplemental source of nitrogen and phosphorus fertilizer. Biosolids also contain all essential plant nutrients, with the possible exception of potassium, to satisfy most crop requirements. As with the addition to soils of other organic materials, such as, for example, hay and animal manures, the addition of organic matter accompanying successive biosolids additions improves the physical properties of soils. This, in turn, exerts a positive influence on water penetration, porosity, bulk density, strength, and aggregate stability.

U.S. Pat. No. 6,021,598, the complete disclosure of which is hereby incorporated herein by reference, discloses an artificial mulch for seedling establishment. Several types of artificial mulches are now commercially produced, each for a particular end use. For example, mulches for hydroseeding and like methods generally contain fluffy, hammered paper compressed into bales. An improvement in such mulches is disclosed in U.S. Pat. No. 6,158,167, which incorporates a surfactant into the mulch material.

Mulch and seed mixtures for crop establishment, particularly turf grass establishment, are available. Such products typically are spread in a dry state onto fields or, in particular, onto bare patches of soil. The mulch serves several purposes, primary of which are protecting the seed from birds, protecting the seed from direct sunlight, and maintaining a moisture content that encourages germination. Seed mulches such as these generally are prepared from paper by hammer milling and like processes, producing a low density, fluffy product. Seed rapidly segregates from such mixtures.

An improvement in seed-containing mulches is the preparation of mulch from paper and finely divided wood products, as disclosed in U.S. Pat. No. 5,916,027. The mulch thus prepared has a density close to that of seed, and thus seed is less likely to segregate during shipping and storage. However, the paper/wood product mulch of U.S. Pat. No. 5,916,027 suffers from the disadvantage that wood products, such as sawdust and waste paper, are not always available.

Segregation of the seeds has been improved upon by the development of a method that provides for a preferably lignocellulosic mulch product that has a density adjusted to the density of the seed with which the mulch is to be used, and which is prepared from a variety of lignocellulosic starting materials (e.g., U.S. Pat. No. 6,349,499). The improvement also provides for unique mulch products, including mulch products having seed attached or incorporated within mulch flakes.

Biosolids are composed to a great extent of cellulose that is derived from the toilet paper and other paper articles that are routinely part of the waste stream. Annually, some 5.8 million tons of toilet tissue paper are produced in the United States, and much of this paper finds its way into the sewage system as toilet paper or feminine hygiene products. The cellulose within the biosolids is not destroyed by routine aerobic or anaerobic digestion, and thus remains as a major portion of the final product produced within wastewater treatment plants. The presence of this cellulose in the biosolid imparts to the biosolids properties that aid in the dewatering of the process, because the material tends to flock together in a fashion similar to dissolved paper as it enters various drying processes. Thus, the cellulose basis of biosolids is a perfect source to be developed into artificial mulches for seed delivery.

Biosolids tend to contain a number of unwanted elements that are disadvantageous for the marketing of fertilizers, compost, or dried solids. Due to the nature of sewage collection, municipal sludges and biosolids contain a number of waste products that are unacceptable to the public because they are unsightly reminders of the source of the material. Such products that appear in sludges commonly consist of things such as, for example, cigarette butts, carriers for tampons, and condoms. Often these materials are removed by various screenings in the sewage treatment plants, but many of the smaller items can pass through systems to become unsightly contaminants of finished soil amending processes. In the production of compost, such materials typically are guaranteed not to be in the final product by the fine sieving of the cured compost. The presence of any of these products in a final product can markedly diminish any use of the material, particularly for lawn care.

Biosolids also contain numerous seeds of domestic plant species that are resistant to the routine treatment processes. The most common example is the seeds of various commonly consumed plants, such as, for example, tomatoes and watermelon. Other seeds that have been noted to regularly survive the various treatment processes are seeds of marijuana plants that have been flushed down toilets and which are observed to grow within sludge drying beds around the United States. If the sludge is to be used for lawn care, such materials must be destroyed before the sludge can be considered appropriate for spreading on lawns.

Biosolids also are known to contain pathogens that include viruses, bacteria, and various parasitic organisms. There are methods that destroy these pathogens, and when sludges are treated by appropriate methods as defined by the United States Environmental Protection Agency, they can be rendered pathogen free. The most commonly used methodology in this format is the treatment of the sludge with heat that can be generated either by external addition or through internal generation by appropriate composting technology. Biosolids that have been treated by one of these methods are termed “Class A,” by the US-EPA. For lawn application, Class A biosolids are the preferred choice.

Mills have been used previously in sludge treatment, but solely for the purpose of lysing the cellular components to assist in pathogen destruction, to improve the production of fine particulates, to prevent the formation of filamentous growth, or to aid in the process of digestion or dewatering (e.g., U.S. Pat. No. 5,240,599; U.S. Pat. No. 5,522,553; U.S. Pat. No. 5,282,980; and U.S. Pat. No. 6,402,065, the complete disclosures of which are hereby incorporated herein by reference).

U.S. Pat. No. 6,464,746 discloses a method for pelletizing slow-release fertilizer. Other processes for converting sludge directly into fertilizer through composting or the addition of greenwaste and lime typically are based on the production and treatment of dry biosolids for direct soil application, rather than as a liquid material formulated specifically for use in artificial horticultural mulches (e.g., U.S. Pat. No. 5,853,450).

### SUMMARY OF THE INVENTION

The present invention provides compositions and methods for preparing plant nutrient rich biosolids and their contained cellulose for use with artificial mulches. The invention provides an organic base for ground cover comprising recycled materials including pathogen-free biosolids and wastepaper combined together with seeds to produce mulch for lawn cover. The invention provides a process for the treatment of the organic wastes from the municipal wastewater stream to produce a product for spreading grass seed in an organic matrix.

In the preferred embodiment, sludges or biosolids are rendered free of foreign objects, sterilized relative to plant seeds, and rendered pathogen free. The sludges are pre-screened or undergo a preliminary grinding, and then milled in a batch or semi-batch format using a rotor-stator mixer (or “mill”). This process is capable through a combination of mixing, the generation of heat through friction, and the effect of cavitation on the contained particulates of rendering the sludge pathogen free and sterile relative to plant seeds. Within the mill, the product optionally is stabilized with the addition of lime, the pH optionally is adjusted, and if necessary, additional materials that would aid in seed germination optionally are mixed into the treated products, such as, for example, plant nutrients, water-retaining compositions, such as peat moss, vermiculite or polyacrylamide, rhizobia, mycorrhizae, and legume inoculant preparations, fertilizer and other plant growth promoters, etc. The treated biosolid is mixed with waste paper products to form a mulch, or pelletized. The final product is a high quality, beneficial re-use organic soil amendment that provides an enriched seed starter system, which is particularly useful for lawns or other commercial turf-grass operations. The use of the milling procedure provides a uniform Class A product that easily can be mixed completely with various chemicals and/or chemical stabilizers to produce a base product for the production of commercial artificial organic mulches that can be used for seeding applications.

### DETAILED DESCRIPTION OF THE INVENTION

The present invention provides compositions and methods for using municipal sewage sludge or biosolids for the production of mulch suitable for the purpose of ground cover when seeding. The preferred embodiment provides an organic base for ground cover comprising recycled materials including pathogen-free biosolids and wastepaper combined together with seeds to produce mulch for lawn cover. The invention provides a novel product especially suited for the generation of a base for mulch generation. The process produces a uniform product rich in plant nutrients and cellulose that serves as a liquid base for generation of artificial mulches. The preferred embodiment includes the steps of prescreening or grinding, milling, and the addition of whatever chemicals are needed as additives for the production of the final product.

The material resulting from the process should be free of objectionable objects commonly present in municipal waste (such as, for example, cigarette butts and plastic products like bottle caps) and be sterile relative to various competing seed types (such as, for example, tomato seeds that remain viable through many treatment processes). Thus, sludges or biosolids that are to be used for this purpose are rendered free of these objects and sterilized relative to plant seeds. Such sludges also are rendered pathogen free, i.e., they are Class A Biosolid as defined by the United States Environmental Protection Agency.

By prescreening or pregrinding sludges with a process such as, for example, that performed by the Muffin Monster (JWC Environmental, Costa Mesa, Calif.), larger products can be removed from the wastewater stream.

The biosolids are introduced into a mill for the purpose of heating and homogenization and to produce a product of uniform small particle size without any inherent problems of identifiable “toilet” contaminants, seeds, or pathogens. The preferred device for this purpose is a rotor-stator mill, which is an efficient, high speed dispersion mill capable of quickly reducing agglomerates to their ultimate particle size, and efficiently producing fine dispersions, suspensions and high quality emulsions. Such mills operate on a principal of impact and attrition utilizing a slotted rotor inside a slotted stator. Acting as a centrifugal pump, the mill forces material through the radial slots and hurls it off the slot tips at 9,000 feet per minute against the stator slots. An appropriate mill for this purpose is the rotor-stator mixer manufactured by Kady International of Scarborough, Me., originally developed for mixing paints and foodstuffs like mustard paste from mustard seeds, vinegar, and other spices.

The mill serves to produce a high quality recyclable base product for mulch production of a highly consistent nature. The milling process generates a completely homogenous biosolids product that is Class A with respect to pathogens. The mill heats the sludge through friction and/or through external heat applied to the mill via an external jacket or through some other similar means. Sludge within the mill optionally is further stabilized through the addition of various routine sludge additives such as, for example, lime or acid, and in a like manner the pH of the finished product can be adjusted to make it optimal for nutrient availability and seed germination.

The mill also serves to remove through dispersion any small remaining “toilet” contaminants such as, for example, cigarette butts that would lower the marketability of the final product. Also, the heat and dispersion of particulates in the mill, which has been used to lyse seeds for the purpose of generating essential oils, insures that the mulch does not contain any seeds of unwanted plants that might contaminate the mulch that will be produced. The mill also can be used optionally to disperse throughout the biosolids any dyes that may be needed to impart the green color typically required for turf replacement applications.

This milling process is capable through a combination of mixing, the generation of heat through friction, and the effect of cavitation on the contained particulates of rendering the sludge pathogen free and sterile relative to plant seeds (e.g., as described in U.S. Pat. No. 6,635,178, the complete disclosure of which is hereby incorporated herein by reference). Within the mill, the product also can be stabilized with the addition of lime, the pH may be adjusted, and if necessary, additional materials that would aid in seed germination or plant growth may be evenly mixed into the treated product.

The present invention is useful for Class A treatment processes generally, and it is contemplated to include methods other than milling (such as, for example, as disclosed in U.S. Pat. No. 5,888,453) to generate similar base products appropriate for the generation of mulch. Other examples of suitable processes for preparing the Class A product include, but are not limited to, thermophylic, aerobic and anaerobic digestion processes, such as, for example, those disclosed in U.S. Pat. Nos. 6,783,679, 4,246,099, and 4,026,793, the complete disclosures of which are hereby incorporated herein by reference.

The treated biosolid is then mixed, using routine methods, with waste paper products to form a mulch, or pelletized, as with a process such as, for example, that of Lebanon Chemical Corporation as described in U.S. Pat. No. 6,464,746. The final product is a high quality, beneficial re-use organic soil amendment that would provide an enriched seed starter system for lawns or other commercial turf-grass operations. The material produced by the treatment of the biosolids with their contained nutrients and cellulose, as described herein, can be used as a base for incorporation with wastepaper for the purposes of generating a mulch for ground cover. It is expected that this mulch would be mixed with seeds for the purpose of generating seeing mulches to take advantage of the nutrients contained within the biosolids, although they could be applied separately.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A horticultural mulch composition, comprising:
i) biosolids and their contained cellulose, recycled from municipal wastewater, that have been rendered pathogen-free, and sterile relative to plant seeds; and
ii) waste paper.

2. The composition of claim 1, wherein said biosolids and their contained cellulose are milled using a rotor-stator mixer or mill.

3. The composition of claim 1, wherein said mulch is fine sieved to remove foreign objects.

4. The composition of claim 1, wherein said mulch is pelletized.

5. The composition of claim 1, further comprising lime or a buffer or composition for adjusting pH.

6. The composition of claim 1, further comprising seed.

7. The composition of claim 6, wherein said seed is selected from the group consisting of grass seed, legume seed, grain seed, herb seed, flower seed, and vegetable seed.

8. The composition of claim 6, wherein said seed is grass seed.

9. The composition of claim 1, further comprising one or more materials that aid in seed germination or plant growth.

10. The composition of claim 9, wherein said one or more materials that aid in seed germination or plant growth is selected from the group consisting of fertilizer, plant nutrients, peat moss, vermiculite, polyacrylamide, water-retaining compositions, rhizobia, mycorrhizae, and legume inoculants.

11. A method for preparing horticultural mulch from biosolids and their contained cellulose, comprising the steps of:
i) providing organic waste including biosolids and their contained cellulose from municipal wastewater;
ii) rendering said organic waste free of foreign objects;
iii) rendering said organic waste pathogen free, and sterile relative to plant seeds;
and
iv) mixing said milled organic waste with waste paper products and/or pelletizing said mixture to form a horticultural mulch.

12. The method of claim 11, further comprising the step of milling said organic waste using a rotor-stator mixer or mill.

13. The method of claim 11, further comprising the step of fine sieving said waste to remove foreign objects.

14. The method of claim 11, further comprising the step of adding lime to said waste.

15. The method of claim 11, further comprising the step of adjusting the pH of said waste.

16. The method of claim 11, further comprising the step of adding seed to said mulch or pelletized mixture, thereby producing a vehicle for spreading seed in an organic matrix.

17. The method of claim 16, wherein said seed is selected from the group consisting of grass seed, legume seed, grain seed, herb seed, flower seed, and vegetable seed.

18. The method of claim 16, wherein said seed is grass seed.

19. The method of claim 11, further comprising the step of adding to said waste one or more materials that aid in seed germination or plant growth.

20. The method of claim 19, wherein said one or more materials that aid in seed germination or plant growth is selected from the group consisting of fertilizer, plant nutrients, peat moss, vermiculite, polyacrylamide, water-retaining compositions, rhizobia, mycorrhizae, and legume inoculants.
